(19) United States
(12) Patent Application Publication
(10) Pub. No.: US 2024/0408499 A1
(43) Pub. Date: Dec. 12, 2024

(54) Augmentation Technology for Sailboat Race Management

(71) Applicant: WhitServe LLC, Stamford, CT (US)

(72) Inventors: Charles Beckman Swanson, JR., Riverside, CT (US); Alec Mackay Macdonald Stewart, San Mateo, CA (US); Wesley W. Whitmyer, JR., Stamford, CT (US); Declan W. Whitmyer, Stamford, CT (US)

(21) Appl. No.: 18/736,905

(22) Filed: Jun. 7, 2024

Related U.S. Application Data
(60) Provisional application No. 63/507,343, filed on Jun. 9, 2023.

(51) Int. Cl. A63F 13/75; A63F 13/2145

(52) U.S. Cl. CPC A63F 13/75; A63F 13/2145; A63F 2300/5586

(57) ABSTRACT

The invention is directed to a system augmenting sailboat race management decisions and includes a portable computing device receiving data indicating at least a position of at least two racing sailboats, with a visual representation of the racing sailboats presented on a display of the portable computing device together with a reference line representing a start, a finish, a stern of one of the two racing sailboats, or a mark. A suggested rule violation by at least one of the two racing sailboats is determined based upon the position data for the two racing sailboats and visually presented on the display. A human interaction with the portable computing device confirms the suggested rule violation and communicates it to a portable computing device on at least the offending sailboat.

### TECHNICAL FIELD

A system is provided using sailboat positions to suggest rule violations to race managers, and then communicate the managers' decisions to competitors using cell phones or sailing instruments.

### BACKGROUND

The latest technology for sailboat racing attempts to automate penalties for rule breaking at the start of a sailboat race. The obvious problem with this approach is that the technology is not good enough to permit automated determination that one or more racing sailboat should be penalized for being over the starting line before the official timed start of a sailboat race, violating the so-called “On Course Side” (OCS) rule of sailboat racing.

All racing sailboat instrument systems use the same satellite data sources for position data and so no sailboat instrument manufacturer can get better data than any other manufacturer. Permitting automated rule calls with data that is commonly only accurate in real world circumstances to within 1-2 meters, is disingenuous at best and dishonest at worst.

Another problem with “modern” sailboat racing instruments is that every single boat in a race needs to have exactly the same piece of $1000+ hardware and every race management team has to have at least 2-3 pieces of the same $1000+ hardware for the system to even be usable. So, the current solution to advise racing sailboats that they have violated the starting rules by being over the starting line too early, OCS, is both cost prohibitive and performs poorly.

A further problem with modern sailboat racing instruments is that the capabilities of the devices are often not permitted to be used by certain classes of sailboats. There are many dozens of different types of racing sailboats. And while they all more or less abide the standardized Racing Rules of Sailing (RRS), each type often has its own supplemental rules which prohibit certain types of electronic devices such as speedometers, mobile phones, and the like from being used in races that involve their type of sailboat. While sailboat racing types, so-called “one-design” classes, are slowly updating their rules to take advantage of modern technology, the pace of rule change and technology adoption is highly variable.

What is desired, therefore, is sailboat racing technology which is cost effective, and which assists race managers with deciding rule violations, like OCS, without removing human intelligence and judgment from the ultimate determination. A system which efficiently communicates confirmed rule violations to competitors using both expensive, special purpose hardware and inexpensive smartphone-based systems is also desired to reduce overall cost by eliminating the necessity to use a costly piece of special purpose hardware to participate in a sailboat race. Finally, it would be desirable to enable race managers operating such a system to limit functionality of both special purpose and smartphone-based sailboat instrument systems in order to comply with particular rules of individual racing sailboat classes.

### SUMMARY

Accordingly, it is an object of invention to provide sailboat race managers with technology which assists them, by providing position data of the racing sailboats, in making determinations about rule violations.

Another object of the invention is to improve overall race quality by using satellite position data but to prevent automated rule violation determinations which are inherently unreliable due to variability of the satellite position data quality.

A further object of the invention is to provide position-based augmentation technology to race managers serving as either principal race officers (PRO) or umpires.

Yet another object of the invention is to provide position-based augmentation technology to race managers at the starting line, at mark roundings, at the finish line, and/or on the racecourse for interpretation of RRS and possible violations thereof.

Still another object of the invention is to provide position-based augmentation technology to race managers which suggests not only which rule(s) might be applicable to a situation based on boat position data, but also suggests which sailboat(s) might have broken which rule(s) based e.g. on computer analysis (expert-system or Al) of both the RRS as well as a catalog of appeals decisions and call books interpreting the rules in different sailboat racing environments.

Yet a further object of the invention is to provide a system with which sailboat race managers can communicate rules violations to sailors having either race specific hardware devices or less expensive, smartphone-based sailing instruments.

Still a further object of the invention is to provide a system to race managers including PROs and/or organizing authorities (OA) with the ability to disable or modify features and capabilities on both special purpose sailboat racing hardware and smartphone-based sailboat racing instruments as needed to comply with class-based, OA or other rules for a particular regatta.

Yet still another object of the invention is to provide a system to race managers which allows them to limit the functionality of special purpose and/or smartphone-based sailboat racing instrument systems in order to comply with particular sailboat class rules.

To achieve one or more of these objects, the invention utilizes the programmability of cellphones and leverages satellite position data into an augmentation technology for sailboat race management teams, including race committees (RC), umpires, and organizing authorities (OA) of sailboat races, where applicable. In all cases, the technology does not make rule violation decisions. Instead, the technology augments human decision makers about when rules may have been broken for action by race managers, umpires and the like. Suggestions may include not only on course side (OCS) decisions, but also luffing rights, mark rounding rights, right of way rights, and other decisions all under the RRS.

In another aspect, the invention addresses the affordability of sailboat racing technology by permitting boats using cell phones to have the same access to RC communications as boats owning and using special purpose $1000+ instruments. As well, since the invention is preferably provided as a smartphone app, race managers also do not need to own special purpose instruments in order to utilize satellite position data to augment their race management and rule violation decisions.

In a further aspect, the invention permits the RC to remotely disable or limit the features available on sailboat racing instruments and/or smartphone apps, so that class and/or OA specific rules can be enforced permitting sailing instruments and apps to be used on multiple boats with variable rules about electronic instruments, satellite instruments and or cell phone use while racing.

### BRIEF DESCRIPTION OF THE DRAWINGS

FIG. 1A is a schematic block diagram of an augmented technology race management system according to the invention.

FIG. 1B is a screenshot of an exemplary RC app for the system of FIG. 1.

FIG. 2A is a screenshot of the app of FIG. 1B numerically indicating distance to line in color, with boats listed numerically for OCS decision.

FIG. 2B is a screenshot of the app of FIG. 1B numerically indicating distance to line in color, with boats listed by relative position on the starting line for OCS decision.

FIGS. 3A-3C are screenshots of the app of FIG. 1B, showing boat 028 swiped with human intervention from clear to OCS despite a satellite reported position behind the starting line at t=0.

FIGS. 4A-4B are schematic screenshots of a portion of the race manager PCD of the system of FIG. 1 graphically indicating boats depicted by relative satellite-position on the starting line and in three bands/zones suggesting clear/green or blue, OCS/red, and human decision/yellow, with boats in the human decision/yellow zone swiped one each to the clear and OCS zones.

FIG. 5 is a schematic screenshot of the system of FIG. 1 graphically indicating a three-boat-length circle reference line, with boats depicted by relative position to the reference line and with a proposed RRS applicable to the depicted sailboats, and with burdens and rights suggested for individual ones of the racing sailboats.

FIG. 6 is a schematic screenshot of the system of FIG. 1 graphically indicating a stern reference line, with boats depicted by relative position to the reference line and with a proposed RRS applicable to the depicted sailboats, and with burdens and rights suggested for individual ones of the racing sailboats.

FIGS. 7A-7B are schematic screenshots of the system of FIG. 1 numerically indicating a satellite-proposed finish order based on a finish reference line, with the ability for race managers to intervene to rearrange the order suggested by the augmentation system.

### DETAILED DESCRIPTION

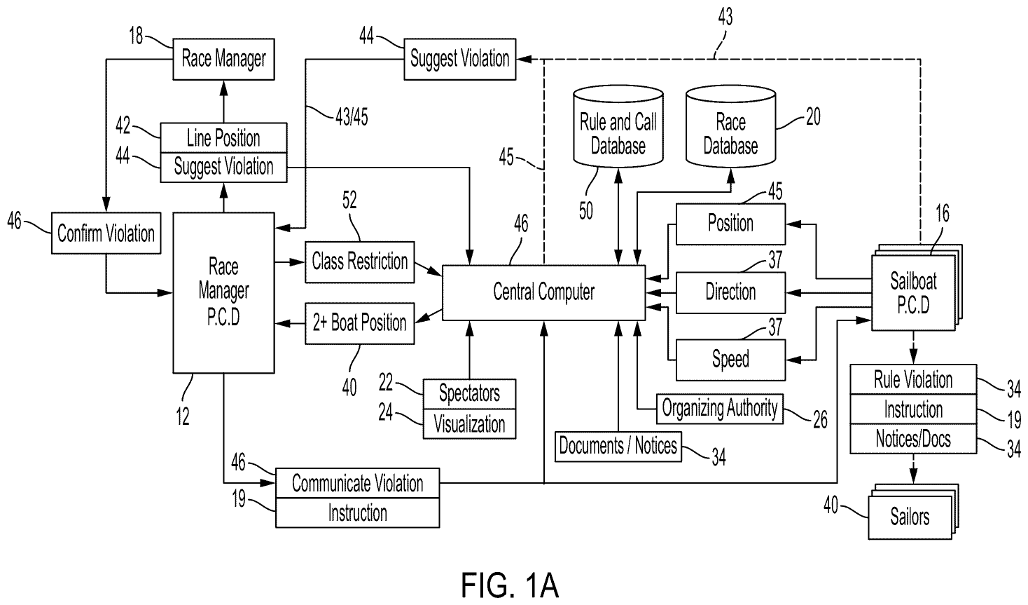

FIG. 1 is a schematic diagram of an augmented technology sailboat race management system 10 in accordance with the invention. System 10 generally includes a race manager portable computing device (PCD) 12, a central computer 14, and two or more sailboat PCDs 16.

A race manager 18, such as a principal race officer (PRO) or her staff, generally interfaces with race manager PCD 12 on a signal boat in order to run sailboat races. In another aspect, race manager 18 might be an umpire making on or off the water rule violation determinations via PCD 12 and assessing penalties on individual ones of the racing sailboats. Race manager 18 can also use PCD 12 to provide instructions 19 to all racing sailboats via PCDs 16. These instructions can include things like race start time, race start system, and the like.

PCDs 12 and 16 may be provided as smartphones, tablets, or special purpose sailboat racing instruments. PCDs 12 operated by race managers 18 are preferably tablets or smartphones having touch screens making them easy and familiar to operate for the required human interactions that inject human judgment into computer-suggested RRS penalties in order to confirm and communicate them to racing sailboats. PCDs 16 are preferably a combination of smartphones, tablets, and special purpose racing instruments in order to extend participation in the augmented sailboat racing system to sailboats having a variety of electronic instrument solutions. Any sailboat with a cellphone can use the system of the invention.

Central computer 14 may be provided as a PCD or server and is preferably connected to data storage and communication services. Race replay is advantageously stored on race database 20 and can be live cast to spectators 22 and/or made available for later replay as a race visualization 24 over the Internet, e.g. through a website and/or conventional telecommunication networks.

A sailboat race organizing authority (OA) 26 which can comprise a yacht club, sailing center, or other sailing association, can access central computer 14 by conventional means such as a web browser to post documents and messages for communication to sailors. These might include a notice or race (NOR), sailing instructions (SIs), protest time and results, race-by-race and cumulative preliminary and final results, social activities and the like.

Sailors 30 receive instructions and rule violation notices 32 from race manager 18 and may also retrieve notices, documents, and other information 34 from the organizing authority 26 through their sailboat PCD 16. Rule violations and race manager instructions are advantageously pushed to sailboat PCDs 16 to ensure timely notification, while OA notices, documents and other information may advantageously be pulled by sailboat PCDs 16 from central computer 14 on an as-needed basis.

More details about the augmented technology sailboat race management system according to the invention can be described with reference to use and operation of system 10. In its most basic implementation, system 10 augments sailboat race management at the start of a sailboat race. In accordance with the RRS, a sailboat race has technically started four minutes prior to the time boats may legally cross the starting line. Depending on the starting system employed and sent to racing sailboat PCDs 16 via instruction, racing sailboats may incur a penalty for passing onto the racecourse side of the starting line at any time within the last minute before the t=0 (where t=time, and 0 is in minutes) official race start, but in all types of sailboat races a racing sailboat incurs a penalty (which may be cumulative) if any part or all of her hull has crossed over onto the racecourse side of the starting line at the t=0 official race start.

A sailboat race start is augmented by system 10 in that at least a position 38 of at least two racing sailboats 40 is communicated to the race manager PCD 12 for presentation to race manager 18 together with a reference line 42 in this case representing the starting line of the sailboat race. At the t=0 official start of the race, race manager 18 also receives a final distance to line (DTL) position of two plus racing sailboats 40 relative to the line position 42, together with a possible suggested RRS violation 44 if one or more of the racing sailboats has any portion of its hull over the starting line 42 at t=0 (or any time after t=1 depending on the starting system used by the RC per instruction 19).

The distance by which a racing sailboat is over the starting line in suggested violation 44 of the RRS is generally calculated by sailboat PCDs 16 on an individual basis such that it can be directly reported to race manager PCD 12 as optionally shown by a dashed line at 43 by the sailboat PCDs 16 themselves, but it could also be calculated by central computer 14 on a collective basis and reported to race manager PCD 12 as optionally shown by dashed line 45. In both cases the racing sailboat position is used to make the calculation of distance to the starting line (DTL) in a conventional manner, which is perpendicular distance to the closest point on the starting line.

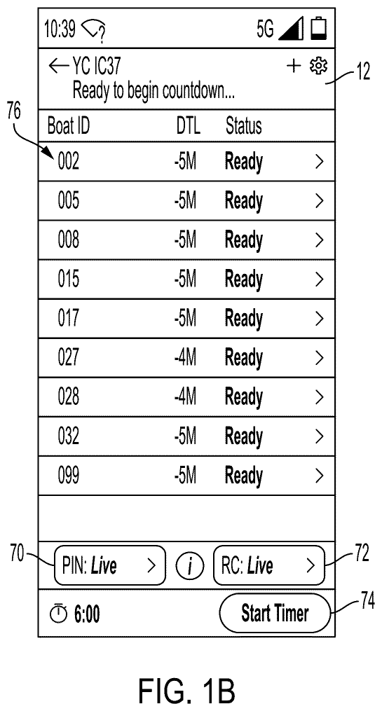

The suggested violation can be presented to race manager 18 in any number of different ways. For example, with reference to FIG. 2A it can be depicted numerically, as a number of meters over the starting line the bow/front of a racing sailboat hull extends onto the racecourse side of the starting line at 83. Also, with reference to the screenshot of FIG. 2A, a clearly OCS boat can be presented in a particular color, e.g. red, while a boat that clearly appears to be well behind the reference starting line is depicted in another color, e.g. blue or green. Boats with satellite-reported positions within a selectable (by race manager 18) margin of error, e.g. 1-2 meters, can conveniently be depicted in a cautionary color, e.g. yellow. In this way the system can be used, if desired, to automatically call boats OCS or clear when their satellite-reported position is well outside the margin for GPS position error, while requiring boats in the cautionary zone of GPS error around the reference starting to require human intervention to determine if they are OCS or clear.

In another mode, system 10 can be used to permit human intervention to overrule the OCS/clear call for all racing sailboats regardless of their reported position relative to the reference starting line. In other words, sailboats reported to be well clear can be confirmed OCS at 46 by race manager 18, while sailboats satellite reported to be well and fully OCS can be confirmed clear. In this mode, system 10 augments the human determination of OCS/clear. As well, in the operating mode in which human intervention is only required or permitted to assess boats in a cautionary zone around the reference line to be confirmed OCS or clear 46, still system 10 augments the human determination of OCS/clear. In a further operating mode, no boats are assumed clear, and human intervention is required for all racing sailboats to indicate clear of OCS.

Additional augmentation to aid race manager can be provided by system 10 in the following manner. Listing the boats in ascending order of the magnitude of the projection of the position of each boat relative to the signal boat onto the starting line allows the race managers located on the signal boat to identify boats that are known to be OCS but whose identifying information (e.g., sail or bow number) is obscured by other boats. Similarly, listing the boats in descending order of this projection can assist race managers located at the pin end of the start line in the same way.

Once a RRS violation is confirmed at 46 by human intervention, it can be communicated at 48 to at least the sailboat PCD 16 of the penalized boat, but possibly also to PCDs 16 of other impacted racing sailboats or even all racing sailboats PCDs.

In addition to position 38 of two or more racing sailboats, system 10 may also utilize direction/heading 37, and speed 39 of racing sailboats. For more complex RRS violations, these additional items of data may be useful to human race managers in confirming violations and assessing penalties. To further augment the human decision, position (and also speed and/or direction) may be used to query rule and call database 50 to retrieve not only one or more suggested relevant RRS, but also any appeal or call decision(s) interpreting the rule(s) with relevance based on position, direction and/or speed that might be relevant to race manager 18 in making a confirmation 46 of a suggested rule violation 44.

It will be understood, that position, speed and/or direction/heading may all be used to augment a race manager 18 determination of a RRS violation even though some or all of these pieces of information are not available to sailors 30 on their smartphones or special purpose racing instruments 16, due to class rule restrictions 52 based on the type of racing sailboat. In other words, race manager 18 could conveniently select a particular type of sailboat class applicable for a given race, e.g. with a dropdown list or otherwise, and that selection could restrict the functionality of sailboat PCDs 16 in order to comply with the special racing rules applicable to that sailboat class. For example, some classes do not permit smartphone use while racing, some do not permit electronic compasses, some permit electronic compasses but not GPS usage for course over ground (COG) and/or speed over ground (SOG) which are useful to quantify the impact of current on a sailboat racecourse, some permit SOG and COG but not GPS tagging of the start line and calculation of DTL, etc. By allowing race managers 18 to restrict functionality of sailboat PCDs 16 in this manner, racing is made fairer while still permitting participants to use their fully-featured sailboat racing instruments on multiple different kinds of racing sailboats, which also lowers cost to sailors.

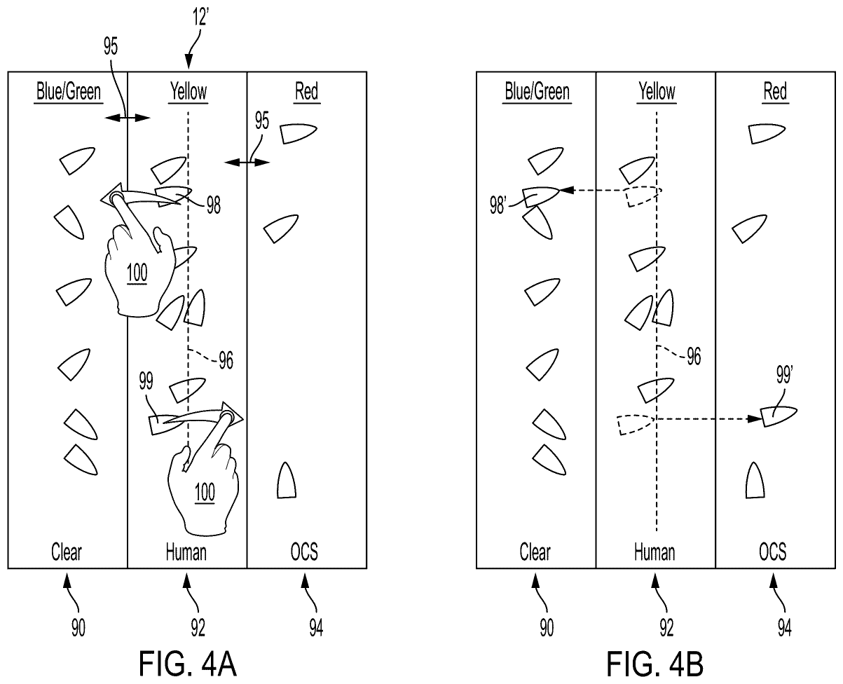

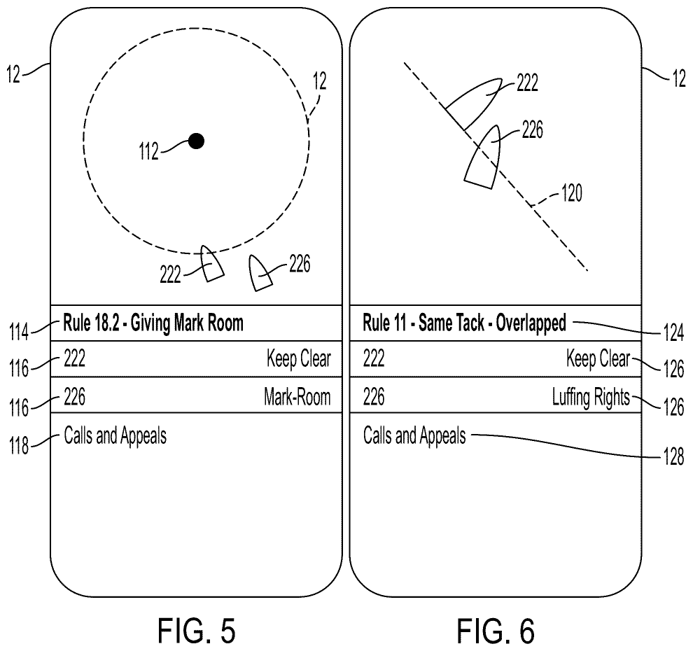

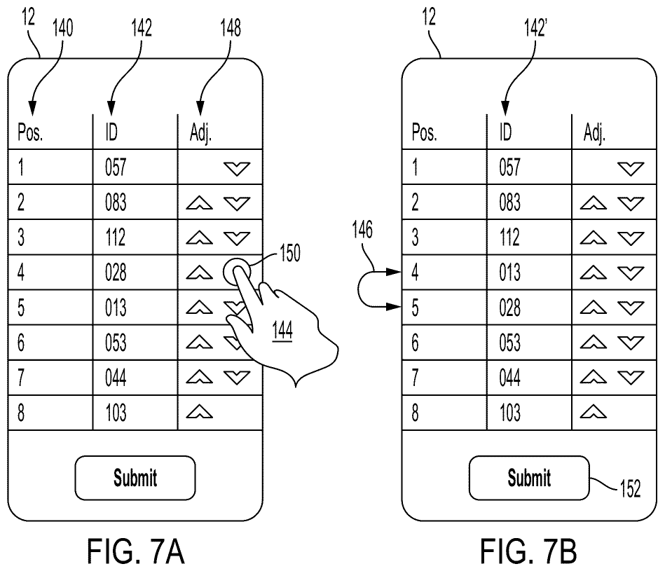

In other examples, system 10 can be used to augment sailboat race management after the start of a sailboat race, for example when boats meet, at mark roundings, the finish, and like situations. In these examples the reference line used to relate positions of multiple sailboats may be a three-boat-length circle (the circle) 60 (see FIG. 5), or an extension of a stern of a boat 62 (see FIG. 6), or a finish line (see FIGS. 7A-7B).

Referring briefly now to FIG. 1B, a screen shot of a smartphone app implementing the features of race manager PCD 12 is shown. Status buttons 70 and 72 shown when signal boat and pin position data is live and button 74 shows when the time signal broadcast to racing sailboats is live and counting down. List 76 is all sailboats competing in the race organized by bow/sail number.

Referring now to FIGS. 2A and 2B, the smartphone app depicted in FIG. 1B is shown in alternate screenshots just after t=0 the official start of the race. Note that the mode of the invention being used requires that any OCS boat be manually swiped to status OCS in column 81. DTL (final) shown in column 83 is color coded and used to suggest OCS boats, but confirmation by swiping a boat into status OCS is required to impose any penalties for communication to the sailboat PCD 16. Note also that in FIG. 2A, the racing sailboats are organized in numerical order in column 80, while in FIG. 2B the racing sailboats are organized in line position order in column 80′. Both versions have their advantages depending on how race manger PCD 12 is used by race manager 18 and her team on the signal boat.

Referring now specifically to FIG. 2A, a skilled RC person will appreciate that boat 015 shows a satellite-reported position that they were 8 meters behind the reference starting line at t=0. The blue (or green) color of the DTL (final) value for boat 015 indicates that it is outside the sensitivity zone of the augmentation system, which is adjustable by race manager 18, such that boat 015 is most likely clear.

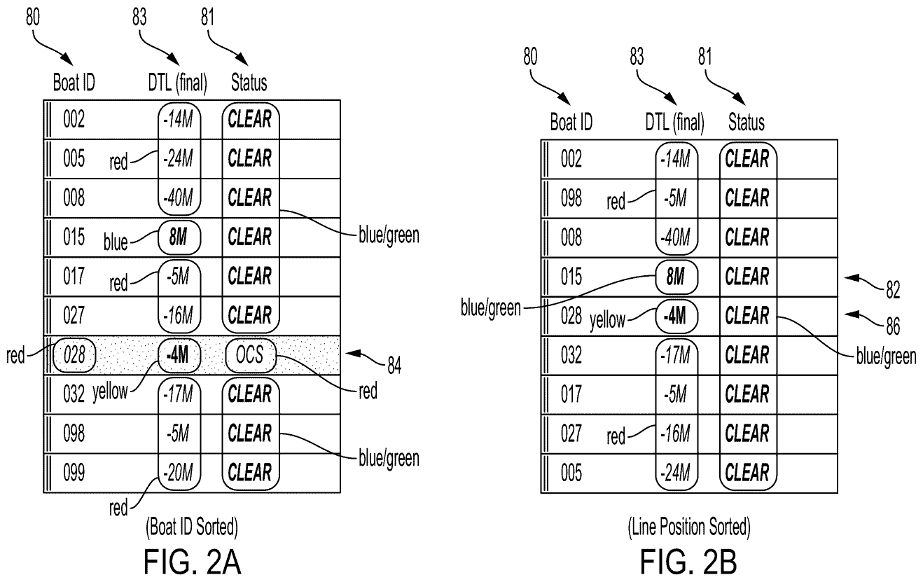

Turning now to boat 028, it shows a DTL (final) in yellow of only 4 meters. The yellow color indicates that it is within the sensitivity zone of the augmentation system and will always require human intervention before any penalties can be imposed. As depicted, even though boat 028 shows a satellite-reported position behind the starting line, it has been swiped at 88 by human intervention to status OCS and will receive a penalty. This action is depicted in the series of FIGS. 3A-3C.

Although the numbers are exaggerated for illustrative purposes, the remaining lines, and boats in FIG. 2A, have DTL (final) values shown in red indicating that all of these boats are outside the sensitivity zone and well over the starting line at t=0 according to the augmentation system. As depicted, these boats are given status clear in blue/green because system 10 is operating in a mode requiring human confirmation before any boat can be punished for a rule violation. The mismatched color of the status and DTL (final) is a prompt to RC personnel and/or race manager 18 to carefully review those boats' statuses. Referring now specifically to FIG. 2B, if the race manager feels boat 028 is not over early, then no swipe is needed at row 86 to leave them with status clear.

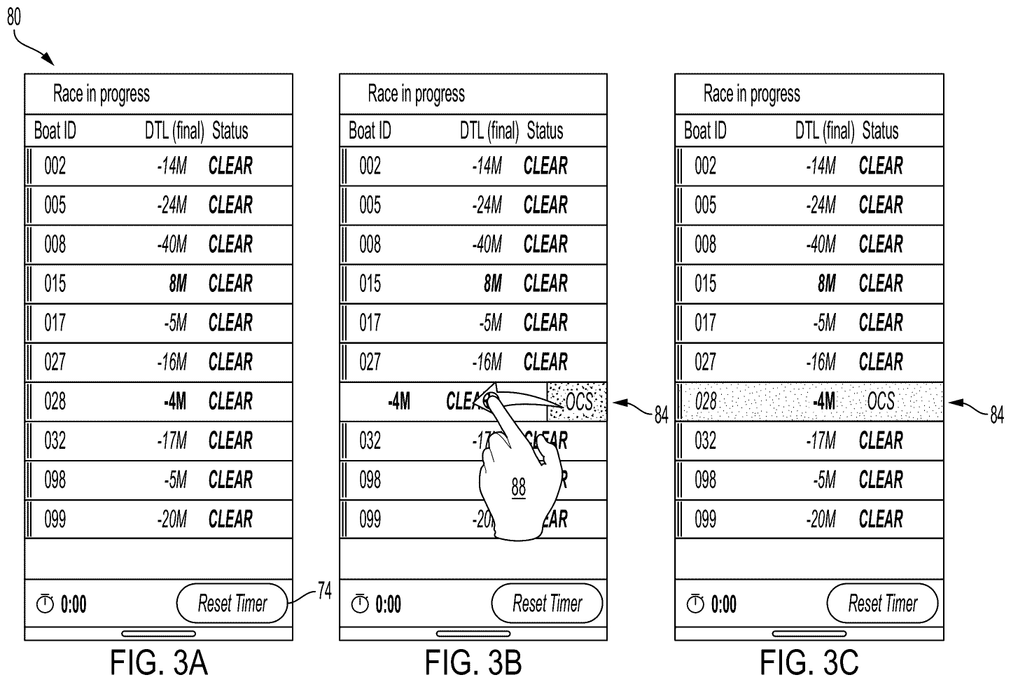

FIGS. 4A-4B illustrate a graphical version of the race manger PCD app 12′ for augmenting human decision about OCS decisions. In this implementation, the screen is divided into three zones: clear or green/blue 90, human required or yellow 92, and OCS or red 94. Racing sailboats are located on the screen of race manager PCD 12 using their satellite-provided positions, and accordingly fall into one or two of the three zones relative to one another and to the starting line 96. The sensitivity of the system can be adjusted at 95 to make the human yellow zone larger or smaller as shown at as desired by race manager 18. Depending on the mode of operation chosen by race manager 18, only boats in the human yellow zone may be swiped to a different zone, or all boats may be swiped into a different zone, or all boats in the human yellow zone must be swiped. As depicted, boat 98 is swiped at 100 from the yellow to the green zone at 98′ where it will definitely have the status clear. And boat 99 is swiped from the yellow to the red zone at 99′ where it will have status OCS. It will be understood that while these are the most common human adjustments to racing sailboat status, they are not the only possible adjustments.

FIGS. 5 and 6 depict a schematic app screen of race manager PCD 12 for use of system 10 to augment application of RRS other than OCS. FIG. 5 is focused on mark rounding and shows the reference line as the circle 110 around a mark 112. Based on the relative positions of boat 222 and 226, system 10 suggests an applicable RRS at 114, suggests a burdened and/or right of way boat at 116 and possibly also suggests a rule violation (not shown). Additionally, the racing sailboat positions, and possibly also speeds and directions may be used to retrieve applicable appeals and calls (for team and match racing) as shown at 118 from database 50. FIG. 6 is focused on luffing and shows the reference line as an extension of the stern 120 of the weather boat 222. Based on the relative positions of boat 222 and 226, system 10 suggests an applicable RRS at 114, suggests a burdened and/or right of way boat at 116 and possibly also suggests a rule violation (not shown). Additionally, the racing sailboat positions, and possibly also speeds and directions may be used to retrieve applicable appeals and calls (for team and match racing) as shown at 118 from database 50.

Referring to both FIGS. 5 and 6, an umpire may for example use the augmentation technology of system 10 to confirm which boat is penalized using a swipe or press on the depiction of the boat to be penalized, followed by automated communication of the penalty to the penalized boat or to all boats involved in the incident.

FIGS. 7A-7B depict a schematic screenshot showing both how the augmentation system of FIG. 1 can propose a finish order based at least on a satellite-proposed position 140 of racing sailboats 142 relative to a reference finish line (not shown), but also how a human intervention 144, such as a finger tap 150, can be used to modify the suggested finish order 142 provided by the augmentation technology of the invention, into a final finish order 142′ in which boat ID 028 has been demoted as shown at 146 by a tap 150 of the down arrow in adjustment column 148. In this way, boats 013 and 028 have changed positions in the final finish order. It will be understood that the same result could have been achieved by promoting boat ID 013 instead of demoting boat ID 028.

Once the preliminary final finish order has been confirmed by human intervention at 144, the submit button 152 can be pressed to communicate preliminary results from race manager PCD 12 directly to racing sailboat PCDs 16. Button 152 can be used to incrementally report preliminary finish order to the racing sailboats with close finishes, or it can be used to a single time per race to report all finishers. In the latter case, the button 152 may if desired be rendered operable only when all registered racing sailboats have finished (of otherwise been accounted for, e.g. if they retire).

This two-step human intervention process can be effective to reduce race manager errors, and also to make competitor communications simultaneous if desired. In cases such as calling OCS boats at the start, simultaneous communication may improve overall fairness of the starting penalty system. It is understood, that the two steps are first to rearrange an ordered list provided by the augmentation technology of the invention, and then to confirm and communicate the race manager decision, penalty etc. in a second human intervention step. In other cases, e.g. where the race manager is only providing information like the starting system to be used for the race, the timing of the communication is fixed or for other reasons, a second human intervention may not be needed or desired.

This description is meant to explain aspects of the invention by example and should not therefore be used to limit any aspect of the invention claimed below in any way.

What is claimed is:

1. A system augmenting sailboat race management decisions, comprising:
a portable computing device having a display;
data, received by said portable computing device, indicative of at least a position of at least two racing sailboats;
a visual representation of said position data for the at least two racing sailboats presented on the display;
a reference line representing a start, a finish, a stern of one of the at least two racing sailboats, or a mark presented on the display;
a suggested rule violation by at least one of the at least two racing sailboats determined based upon said position data for the at least two racing sailboats, said suggested rule violation visually indicated on the display;
a human interaction with said portable computing device confirming said suggested rule violation; and
wherein said human interaction causes communication of the confirmed rule violation to a second portable computing device on at least one of the at least two racing sailboats.

2. The system of claim 1 wherein said visual representation is a graphical indication.

3. The system of claim 1 wherein said visual representation is a number.

4. The system of claim 3 wherein said visual representation includes color.

5. The system of claim 1 wherein said portable computing device is a smartphone.

6. The system of claim 1 wherein the second portable computing device is a smartphone.

7. The system of claim 1 wherein the second portable computing device is a special purpose sailboat racing instrument.

8. The system of claim 1 wherein said suggested rule violation can be presented as an image, text, rule or graphic.

9. The system of claim 8 wherein said suggested rule violation is an OCS boat presented by a distance over a starting line.

10. The system of claim 9 wherein the distance is presented numerically.

11. The system of claim 1 wherein said human interaction includes a swipe.

12. The system of claim 1 wherein said human interaction includes a secondary confirmation.

13. The system of claim 12 wherein the secondary confirmation synchronizes rule violation communications.

14. The system of claim 1 wherein said data is also indicative of a speed of each of the at least two racing sailboats.

15. The system of claim 1 wherein said data is also indicative of a direction of each of the at least two racing sailboats.

16. The system of claim 1 wherein said visual representation includes a direction that each of the at least two racing sailboats is heading.

17. The system of claim 1 wherein said visual representation includes a speed that each of the at least two racing sailboats is heading.

18. The system of claim 1 including a database of interpretations of violations of RRS accessible to said portable computing device and wherein said data from said at least two racing sailboats can be used to access said database to present said suggested rule violations.

19. The system of claim 1 including a database of interpretations of violations of RRS accessible to said portable computing device and wherein said data from said at least two racing sailboats can be used to access said database to present said suggested rule violations.

20. The system of claim 1 wherein communication of the confirmed rules violation is transmitted to both at least one smartphone and a special purpose sailboat racing instrument.

21. The system of claim 1 wherein the confirmed rules violation is transmitted for display as text on the second portable computing device.

22. The system of claim 1 wherein said portable computing device can limit functionality on each of the second portable computing devices.

23. A system augmenting sailboat race management decisions, comprising:
a portable computing device having a display;
data, received by said portable computing device, indicative of at least a position of at least two racing sailboats;
an ordered list of said at least two racing sailboats compiled from said position data for the at least two racing sailboats and a reference line representing a start, a finish, a mark rounding or a stern of one of the at least two racing sailboats, said ordered list presented on the display;
a suggested rule violation by at least one of the at least two racing sailboats presented in said ordered list on the display using either color, or DTL (final) or screen position relative to the reference line based upon said position data for the at least two racing sailboats;
a human interaction with said portable computing device confirming said suggested rule violation; and
wherein said human interaction causes communication of the confirmed rule violation to a second portable computing device on at least one of the at least two racing sailboats.
